(19) United States
(12) Patent Application Publication
(10) Pub. No.: US 2020/0281332 A1
(43) Pub. Date: Sep. 10, 2020

(54) WEARABLE ELECTRONIC DEVICE WITH PREDETERMINED LOCATIONS INTENDED TO EXCEED MATERIAL STRESS LIMITS TO REDUCE INJURY.

(71) Applicants: ALEXANDER KARP, ESCONDIDO, CA (US); Michael Chapp, San Francisco, CA (US)

(72) Inventors: ALEXANDER KARP, ESCONDIDO, CA (US); Michael Chapp, San Francisco, CA (US)

(21) Appl. No.: 16/813,228

(22) Filed: Mar. 9, 2020

Related U.S. Application Data
(60) Provisional application No. 62/815,271, filed on Mar. 7, 2019.

(51) Int. Cl. A44C 9/00; G06F 1/16

(52) U.S. Cl. CPC A44C 9/0053; G06F 1/163

(57) ABSTRACT

The present disclosure describes a wearable electronic device, having at least one pre-formed stress point that is readily broken when subjected to an excessive external force, thereby causing the wearable to separate, rather than transferring forces, and potential injury, to a user.

### RELATED APPLICATION

This is a regular U.S. application claiming priority to U.S. Provisional Application Ser. No. 62/815,271, entitled Apparatus To Reduce Injury By Dissipating Physical Energy Through Pre-determined Locations Intended To Exceed Material Stress Limits, filed on Mar. 7, 2019, the contents of which are herein incorporated by reference as if set forth in their entirety.

### FIELD OF THE INVENTION

The present invention is directed to wearable electronic devices, and methods of use thereof. Particularly, the disclosure is directed to wearable electronic devices with at least one member formed to rigidly, semi-rigidly, and/or flexibly couple with a portion of the body of a user.

### BACKGROUND

Wearable electronics are an emerging technology with many applications for the wearer. Often these wearables are intended to directly interact with the wearer's body to help monitor activity within the wearer's body. Sensors, input devices, or output devices in these wearable electronic devices often require proximity to specific locations on the user to perform the intended function of the wearable. Many of these wearables are manufactured to be formed on specific portions of the user's body by overlapping or partially overlapping said specific portion of said user. Often, these wearables require sufficient coupling strength or force to prevent inadvertent slippage or movement from the desired location on said user and therefore employ hard or semi-rigid materials. These wearables are intended to be worn for extended periods of time and during various activities. External forces may be applied to the wearable as the user interacts with physical surroundings. If these external forces are sufficiently high, the user may experience injury such as degloving. Degloving may occur when a watch or ring is hooked or snagged with excessive force which transfers the force into the body where the wearable is attached. Similarity, a person wearing a ring may incur a minor injury that elicits an inflammation response whereby the inflammation causes the finger swells against the ring, increasing pressure and restricting blood flow through the finger. In both causes, more severe injury is likely to occur due to the ridge materials used to manufacture these wearables.

### SUMMARY OF THE INVENTION

This invention overcomes the disadvantages of the prior art by providing a wearable electronic device having at least one pre-formed stress point that is readily broken when subjected to an excessive external force, thereby causing the wearable to separate, preventing said force being transferred to the wearer.

In one embodiment, the wearable comprises a hard or semi-rigid member, an electronic device housed within, and a first axial pre-formed stress point such that the member will break at said pre-formed stress point when said member is subjected to a predetermined load.

In one embodiment, the wearable comprises a hard or semi-rigid annual member, an electronic device housed within, and a first axial pre-formed stress point such that the member will break at said pre-formed stress point when said member is subjected to a predetermined load.

In one embodiment, the wearable comprises a hard or semi-rigid member, an electronic device housed within, and a first radial pre-formed stress point such that said member will break at said pre-formed stress point when said member is subjected to a predetermined load.

In one embodiment, the wearable comprises a hard or semi-rigid annual member, an electronic device housed within, and a first radial pre-formed stress point such that said member will break at said pre-formed stress point when said member is subjected to a predetermined load.

In one embodiment, the wearable comprises a first interior bounding annual member formed of sufficiently low-strength hard or semi-rigid material, a second exterior bounding annual member formed of sufficiently high-strength hard or semi-rigid material, an electronic device housed within, and a first axial pre-formed stress point formed in said second member such that both first and second members will break at said pre-formed stress point when first or second member is subjected to a predetermined load.

In one embodiment, the wearable comprises a first interior bounding annual member formed of hard or semi-rigid material, a second exterior bounding annual member formed of hard or semi-rigid material, an electronic device housed within, and a first axial pre-formed stress point formed in said first member, a second axial pre-formed stress point formed in said second member, such that second pre-formed stress point is planarity aligned with first pre-formed stress point, such that when said first or said second member is subjected to a predetermined load, both said first member and said second member will experience material stress greater than the ultimate strength of said first member material and said second member material, causing the annual members to separate at the said first pre-formed stress point and said second pre-formed stress point, simultaneously.

In accordance with yet a further aspect of the present invention, the pre-formed stress point comprises a cross-sectional area of reduced material.

Further, the reduction in cross-sectional area may be formed with sufficiently small radii thereby selectively increasing localized material stress when said pre-formed stress point is subjected to bending forces.

The embodiments of the invention may be formed during the creation of the device, including but not limited to, forging, molding, stamping, and 3D printing. Further, the embodiments of the invention may be added during subsequent manufacturing processing, including but not limited to sawing, milling, and shaping.

Additionally, variation in wearer's body and portions of the wearer's body, may require adjustment to the pre-formed stress point locations and a multiplicity of pre-formed stress point locations. Example, a user with more fragile fingers may require a very low predetermined load able to separate a wearable device when compared to a user with relatively less fragile fingers.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1A is a top side view of the wearable according to one or more aspects of the disclosure;

FIG. 1B is a front view of the wearable according to one or more aspects of the disclosure;

FIG. 1C is a cross section of the wearable along the line A-A of FIG. 1B;

FIG. 2A is a top side view of the wearable according to one or more aspects of the disclosure;

FIG. 2B is a front view of the wearable according to one or more aspects of the disclosure;

FIG. 2C is a cross section of the wearable along the line B-B of FIG. 2B;

FIG. 3A is a top side view of the wearable according to one or more aspects of the disclosure;

FIG. 3B is a front view of the wearable according to one or more aspects of the disclosure;

FIG. 3C is a cross section of the wearable along the line C-C of FIG. 3B;

FIG. 4A is a top side view of the wearable according to one or more aspects of the disclosure;

FIG. 4B is a front view of the wearable according to one or more aspects of the disclosure;

FIG. 4C is a cross section of the wearable along the line D-D of FIG. 4B;

FIG. 5A is a top side view of the wearable according to one or more aspects of the disclosure;

FIG. 5B is a front view of the wearable according to one or more aspects of the disclosure;

FIG. 5C is a cross section of the wearable along the line E-E of FIG. 5B;

FIG. 6A is a top side view of the wearable according to one or more aspects of the disclosure;

FIG. 6B is a front view of the wearable according to one or more aspects of the disclosure;

FIG. 6C is a cross section of the wearable along the line F-F of FIG. 6B;

FIG. 7A is a top side view of the wearable according to one or more aspects of the disclosure;

FIG. 7B is a front view of the wearable according to one or more aspects of the disclosure;

FIG. 7C is a cross section of the wearable along the line G-G of FIG. 7B;

FIG. 8A is a top side view of the wearable according to one or more aspects of the disclosure;

FIG. 8B is a front view of the wearable according to one or more aspects of the disclosure;

FIG. 8C is a cross section of the wearable along the line H-H of FIG. 8B;

FIG. 9A is a top side view of the wearable according to one or more aspects of the disclosure;

FIG. 9B is a front view of the wearable according to one or more aspects of the disclosure;

FIG. 9C is a cross section of the wearable along the line J-J of FIG. 9B;

FIG. 10A is a top side view of the wearable according to one or more aspects of the disclosure;

FIG. 10B is a front view of the wearable according to one or more aspects of the disclosure;

FIG. 10C is a cross section of the wearable along the line K-K of FIG. 10B;

FIG. 11 is a perspective view of an embodiment of the invention substantially coupled to a portion of the body of a user according to one or more aspects of the disclosure;

### DETAILED DESCRIPTION

A detailed description of the hereinafter described embodiments of the disclosed apparatus are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

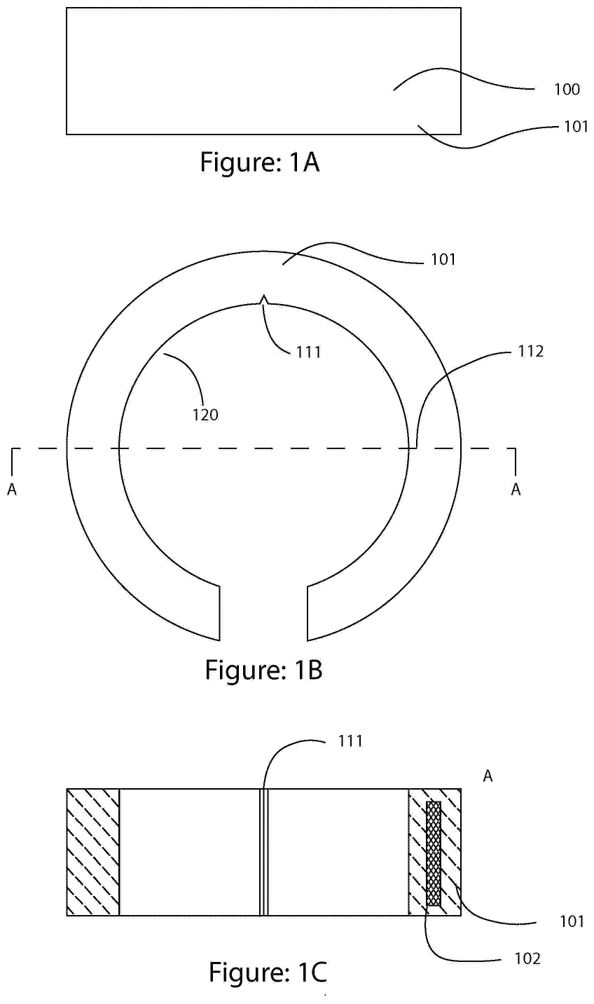

With reference to FIG. 1A, FIG. 1B, and FIG. 1C, a wearable device 100 includes a member 101 made of a hard or semi-rigid material such as metal or plastic, an electronic device 102 housed within, an interior surface 120 intended to substantially couple with a portion of the body of a user. Member 101 having formed within, a first axial pre-formed V-channel 111 such that internal stress of member 101 will exceed the ultimate material stress at pre-formed V-channel 111 when member 101 is subjected to external load which imparts tensile stresses in pre-formed channel 111, such as bending moment aligned to the axial orientation of interior surface 120.

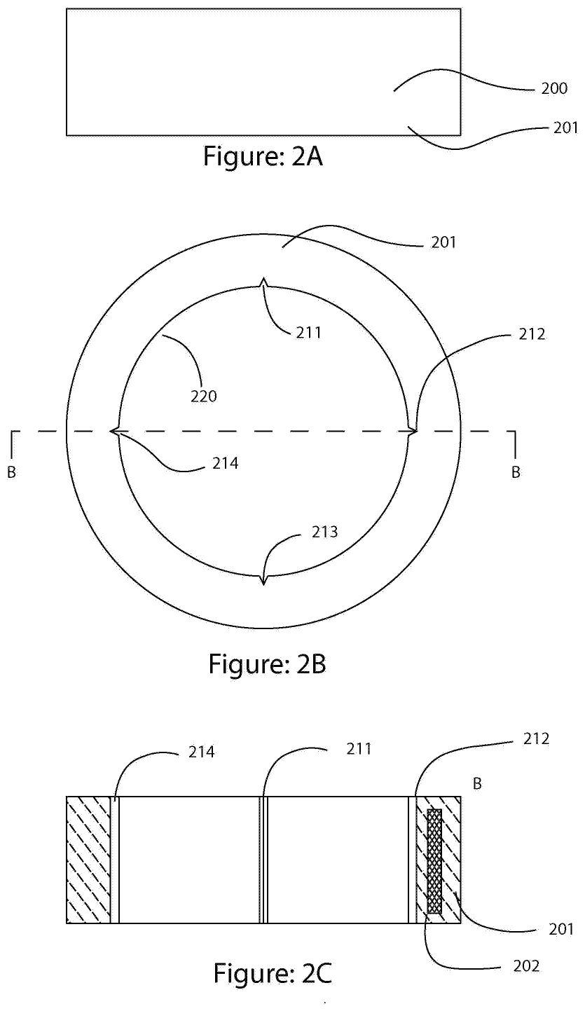

With reference to FIG. 2A, FIG. 2B, and FIG. 2C, a wearable device 200 includes an annual member 201 made of a hard or semi-rigid material such as metal or plastic, an electronic device 202 housed within, an interior surface 220 intended to substantially couple with a portion of the body of a user. Member 201 having formed within, a first axial pre-formed V-channel 211, a second axial pre-formed V-channel 212, a third axial pre-formed V-channel 213, a fourth axial pre-formed V-channel 214, such that internal stress of member 201 will exceed the ultimate material stress limit at pre-formed V-channel 211, 212, 213, 214 when member 201 is subjected to external load which imparts tensile stresses in pre-formed channel 211, 212, 213, 214, such as bending moment aligned to the axial orientation of interior surface 220.

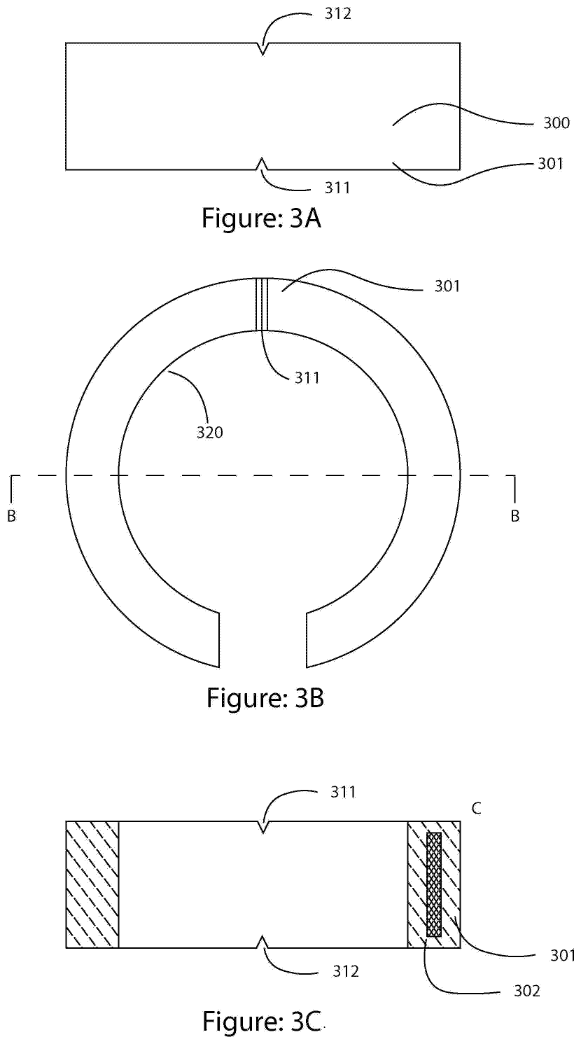

With reference to FIG. 3A, FIG. 3B, and FIG. 3C, a wearable device 300 includes a member 301 made of a hard or semi-rigid material such as metal or plastic, an electronic device 302 housed within, an interior surface 320 intended to substantially couple with a portion of the body of a user. Member 301 having formed within, a first radial pre-formed V-channel 311, a second radial pre-formed V-channel 312, such that internal stress of member 301 will exceed the ultimate material stress limit at pre-formed V-channel 311, 312, when member 301 is subjected to external load which imparts tensile stresses in pre-formed channel 211, 212, such as bending moment orthogonal to the axial orientation of interior surface 320.

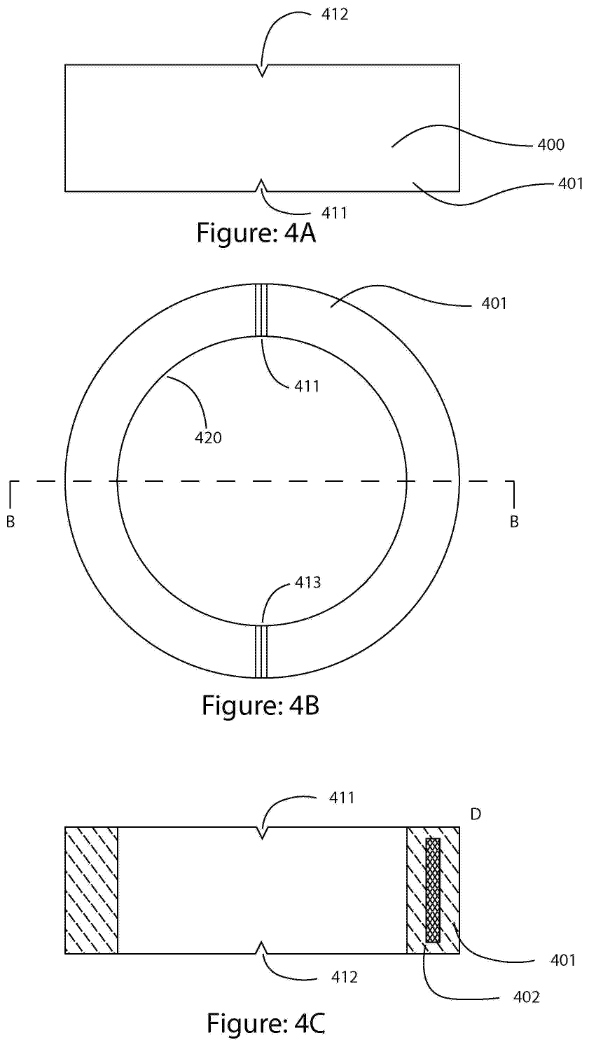

With reference to FIG. 4A, FIG. 4B, and FIG. 4C, a wearable device 400 includes an annual member 401 made of a hard or semi-rigid material such as metal or plastic, an electronic device 402 housed within, an interior surface 420 intended to substantially couple with a portion of the body of a user. Member 401 having formed within, a first radial pre-formed V-channel 411, a second radial pre-formed V-channel 413 planarly aligned to 411, a third radial pre-formed V-channel 412, such that internal stress of member 401 will exceed the ultimate material stress limit at pre-formed V-channel 411, 412, 413, when member 401 is subjected to external load which imparts tensile stresses in pre-formed channel 411, 412, 413, such as bending moment orthogonal to the axial orientation of interior surface 320.

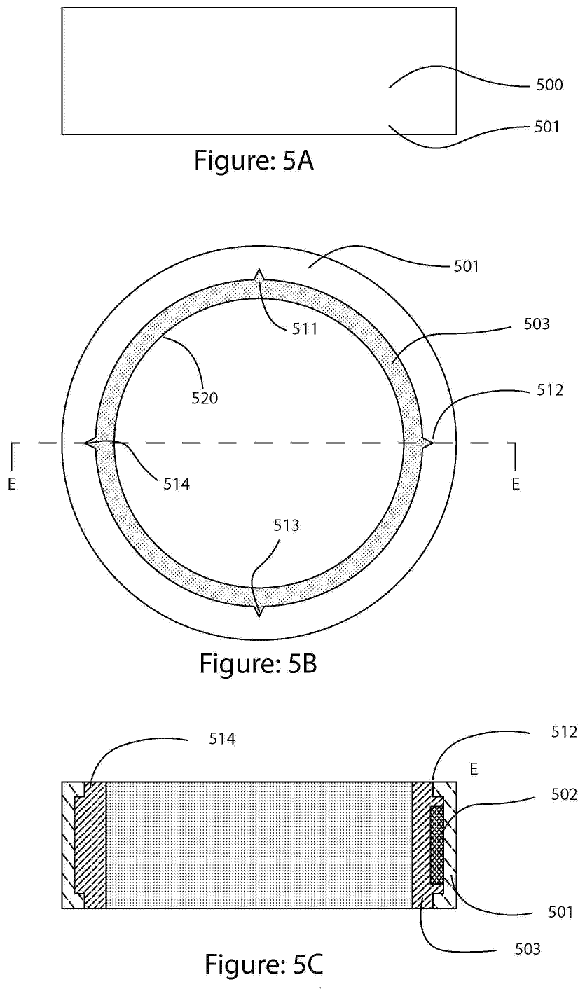

With reference to FIG. 5A, FIG. 5B, and FIG. 5C, a wearable device 500 includes a first annual member 501 made of a hard or semi-rigid material such as metal or plastic, a second annual member 503 made of a hard or semi-rigid material, an electronic device 502 housed within, an interior surface 520 intended to substantially couple with a portion of the body of a user. Member 501 having formed within, a first axial pre-formed V-channel 511, a second axial pre-formed V-channel 512, a third axial pre-formed V-channel 513, a fourth axial pre-formed V-channel 514, such that internal stress of member 501 will exceed the ultimate material stress at pre-formed V-channel 511, 512, 513, 514, and that internal stress of member 503 will exceed the ultimate material stress limit in close proximity to at pre-formed V-channel 511, 512, 513, 514, when member 501 is subjected to external load which imparts tensile stresses in pre-formed channel 511, 512, 513, 514, such as bending moment aligned to the axial orientation of interior surface 520.

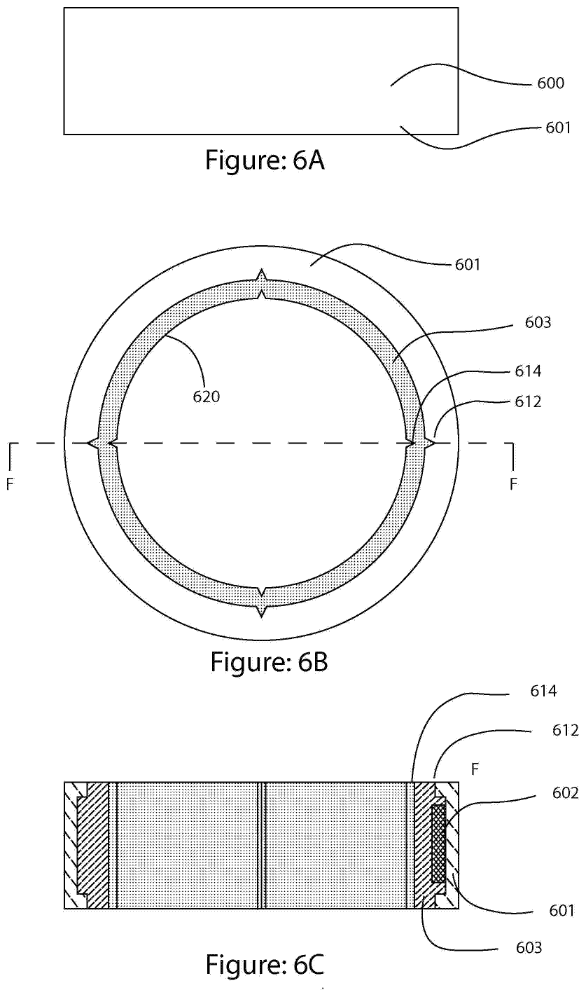

With reference to FIG. 6A, FIG. 6B, and FIG. 6C, a wearable device 600 includes a first annual member 601 made of a hard or semi-rigid material such as metal or plastic, a second annual member 603 made of a hard or semi-rigid material, at least one electronic device 602 housed within, an interior surface 620 intended to substantially couple with a portion of the body of a user. Member 601 having formed within, at least one axial pre-formed V-channel 612, Member 603 having formed within, at least one axial pre-formed V-channel 614 planarly aligned with pre-formed V-channel 612, such that internal stress of member 501 will exceed the ultimate material stress at pre-formed V-channel 612, and that internal stress of member 603 will exceed the ultimate material stress limit at pre-formed V-channel 614, when member 601 or member 603 is subjected to external load which imparts tensile stresses in pre-formed channels 612, and pre-formed channel 614, such as bending moment aligned to the axial orientation of interior surface 620.

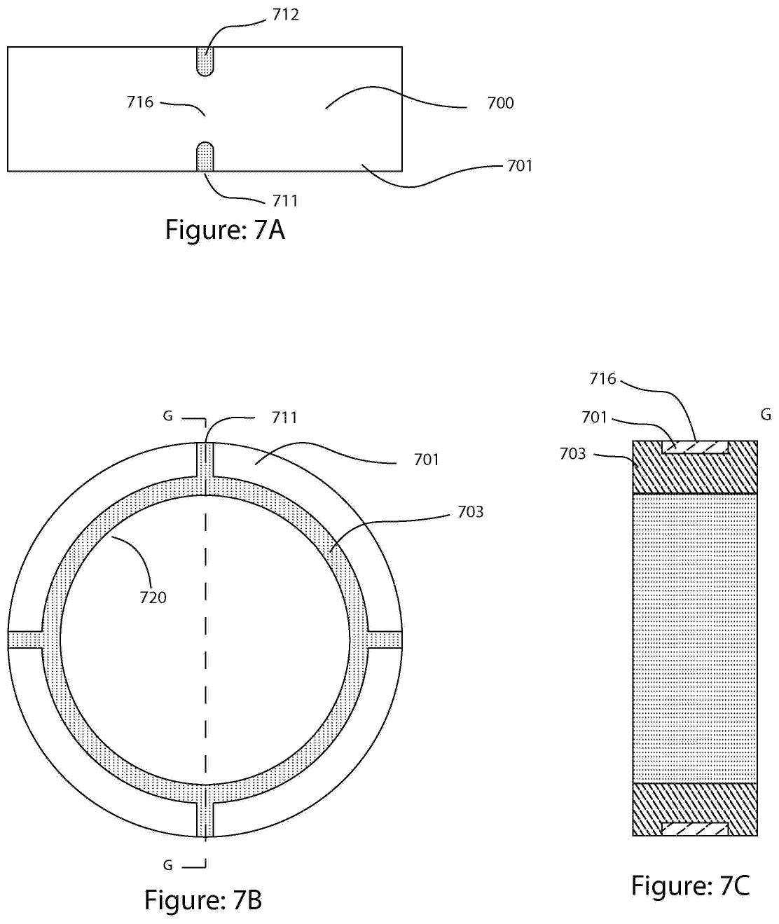

With reference to FIG. 7A, FIG. 7B, FIG. 7C, a wearable device 700 includes a first annual member 701 made of a hard or semi-rigid material such as metal or plastic, a second annual member 703 made of a hard or semi-rigid material with lower ultimate strength relative to member 701, at least one electronic device 702 housed within, an interior surface 720 intended to substantially couple with a portion of the body of a user. Member 701 having formed within, a first channel 712, a second channel 711 aligned to channel 712 to form a cross-sectional area of reduced material 716. Cross-sectional area 716 is sufficiently small, such that predetermined external tensile forces, bending forces, compressive forces, and torsional forces acting on member 701 or member 703 will impart internal stress in close proximity to reduced cross-sectional area 716.

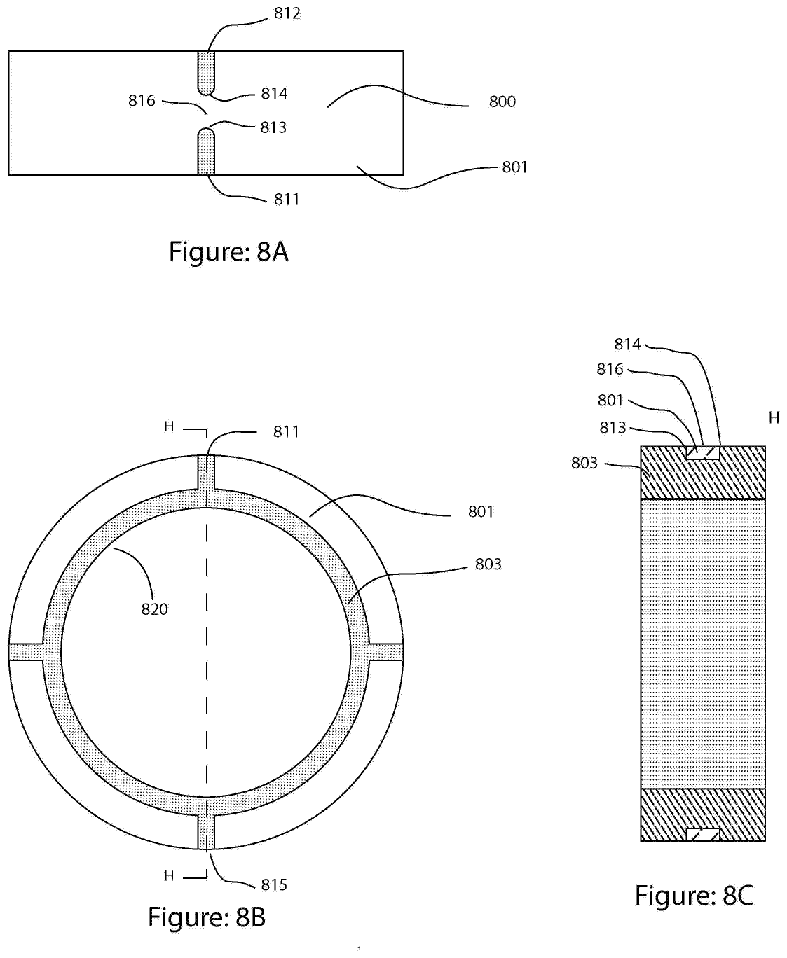

With reference to FIG. 8A, FIG. 8B, FIG. 8C, a wearable device 800 includes a first annual member 801 made of a hard or semi-rigid material such as metal or plastic, a second annual member 803 made of a hard or semi-rigid material with lower ultimate strength relative to member 801, at least one electronic device 802 housed within, an interior surface 820 intended to substantially couple with a portion of the body of a user. Member 801 having formed within, a first channel 812, a second channel 811 aligned to channel 812 to form a cross-sectional area of reduced material 816. Reduced cross-sectional area 816 is relatively smaller compared to reduced cross-sectional area 716, such that wearable device 800 will separate at lower external forces compared to similar forces applied to device 700.

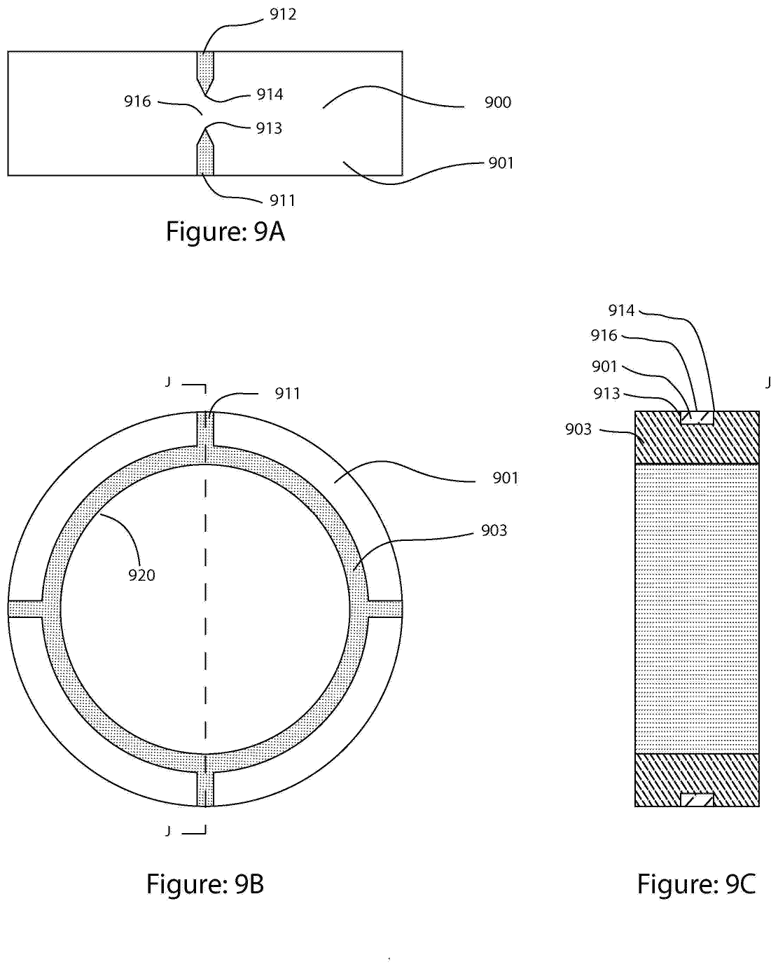

With reference to FIG. 9A, FIG. 9B, FIG. 9C, a wearable device 900 includes a first annual member 901 made of a hard or semi-rigid material such as metal or plastic, a second annual member 903 made of a hard or semi-rigid material, at least one electronic device 902 housed within, an interior surface 920 intended to substantially couple with a portion of the body of a user. Member 901 having formed within, a first channel 912, a second channel 911 aligned to channel 912 to form a cross-sectional area of reduced material 916. Further, channels 911 and 912 are formed with relatively small radii 913 and 914 when compared to radii 813 and 814, such that internal stress of member 901 will exceed the ultimate material stress limit at pre-formed 913 and 914, when member 901 is subjected to a predetermined external load that would otherwise not exceed the ultimate material stress limit at pre-formed 813 and 814, when member 801 is subjected to a similar predetermined external load.

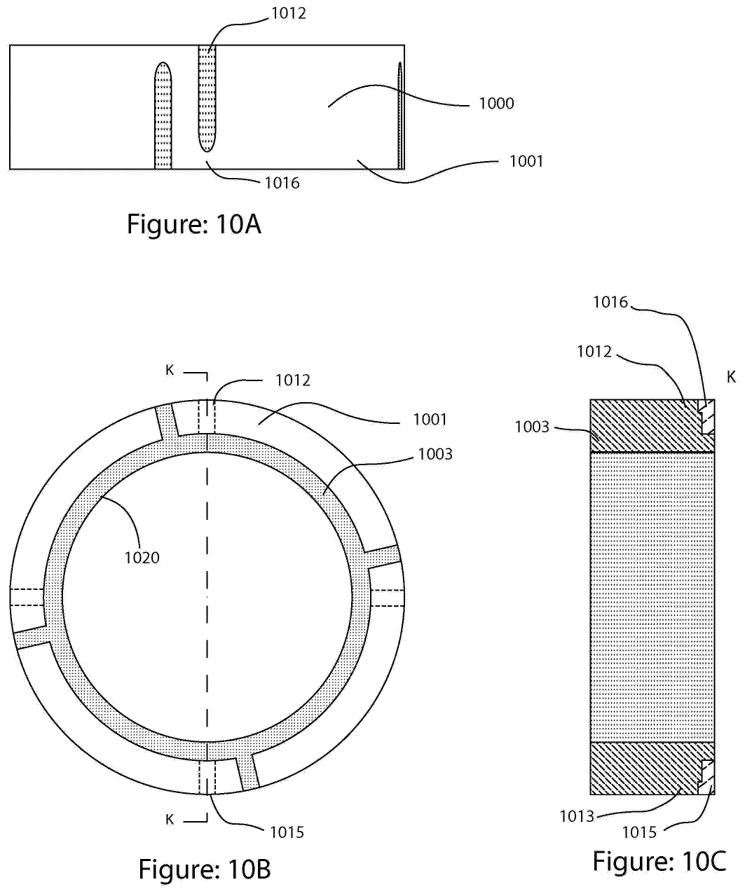

With reference to FIG. 10A, FIG. 10B, FIG. 10C, a wearable device 1000 includes a first annual member 1001 made of a hard or semi-rigid material such as metal or plastic, a second annual member 1003 made of a hard or semi-rigid material, at least one electronic device 1002 housed within, an interior surface 1020 intended to substantially couple with a portion of the body of a user. Member 1001 having formed within, a first channel 1012, forming a cross-sectional area of reduced material 1016, a second channel 1013, radially opposed to channel 1012, forming a cross-sectional area of reduced material 1015, such that

when member 1001 or member 1003 is subjected to a predetermined external load which imparts tensile stresses in channels 1012, internal material stress of member 1003 will exceed the ultimate material stress of member 1003 allowing the device 1000 to separate.

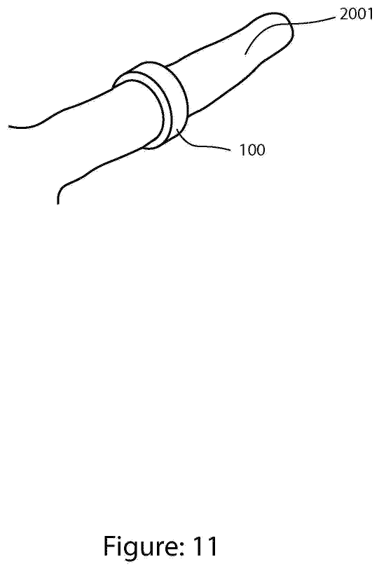

With reference to FIG. 11, a wearable device 100 is substantially coupled to a portion of the body of the user 2001, such that the device 100 grips the portion of the body with sufficient strength or force without inadvertent slippage.

What is claimed:

1: a wearable device, comprising:
A member configured to be substantially coupled to the user,
An electronic device,
A first channel formed within said member to define a low mechanical strength zone.

2: The wearable device of claim 1, further comprising a second channel formed within said member, planarly aligned with said first channel.

3: The wearable device of claim 1, further comprising said first channel configured to define a pre-formed break point that will fracture when subjected to a predetermined load.

4: a wearable device, comprising:
An annular member defining a through opening sized to receive a portion of the body of the user therein,
An electronic device,
A first channel formed within said annual member to define a low mechanical strength zone.

5: The wearable device of claim 4, further comprising a second channel formed within said member, planarly aligned with said first channel.

6: The wearable device of claim 4, further comprising said first channel configured to define a pre-formed break point that will fracture when subjected to a predetermined load.

7: a wearable device, comprising:
An annular member defining a through opening sized to receive the finger of the user's hand therein;
An electronic device,
A channel formed within said annual member to define a low mechanical strength zone

8: The wearable device of claim 6, further comprising a second channel formed within said member, planarly aligned with said first channel.

9: The wearable device of claim 6, further comprising said first channel configured to define a pre-formed break point that will fracture when subjected to a predetermined load.
